(19) United States
(12) Patent Application Publication
(10) Pub. No.: US 2013/0066686 A1
(43) Pub. Date: Mar. 14, 2013

(54) AUTOMATIC TEST ORDER GENERATION FOR A RETAIL SHOPPING SERVICE

(71) Applicants: Zachary Danielson, Chicago, IL (US); Lauren Beth Polkow, Chicago, IL (US)

(72) Inventors: Zachary Danielson, Chicago, IL (US); Lauren Beth Polkow, Chicago, IL (US)

(21) Appl. No.: 13/227,771

(22) Filed: Sep. 8, 2011

(51) Int. Cl. G06Q 10/00; G06Q 50/00

(52) U.S. Cl. 705/7.39

(57) ABSTRACT

A restaurant service automatically generates test orders comprised of items selected to minimize the cost and/or inconvenience to participating restaurants that accidentally prepare the test order.

### CROSS REFERENCE TO RELATED APPLICATIONS

NONE

### FIELD OF THE INVENTION

The present invention relates to a system and method of providing a retail shopping service, and more particularly relates to a system and method of providing a retail shopping service that provides shoppers with an electronic catalogue of options through a variety of mediums, whereby a number of third party merchants fulfill orders sourced by the shopping service, and more particularly still relates to a system and method of automatically generating test orders to guarantee that participating merchants quickly service orders generated through the service.

### DESCRIPTION OF THE PRIOR ART

Third party shopping catalogues are well known in the art. Such catalogues, distributed by a shopping service, would feature the products of multiple merchants. The catalogue merchant would accept orders and payment from customers. The orders, along with a portion of the payment were sent to product merchants, who would then fulfill the orders. In more recent times, a number of web sites have assumed this model. For example, certain web sites route orders to participating merchants for a fee.

Restaurants traditionally have not participated in shopping services because, unlike non-perishable goods, food generally should be consumed shortly after preparation. However, the adoption of the Internet has made restaurant shopping services feasible, as diners can be given a selection of restaurants within a specified distance of their location. Food can then be delivered to them, or diners can go to the restaurant to pick up their order.

All shopping services that make use of third party merchants require a means to ensure that those merchants are responding to customer orders placed through the shopping service, as failures by the merchants to service customers will reflect poorly on the shopping service. Traditionally, customer service representatives have periodically contacted merchants participating in the shopping service to ensure that they were still accepting orders. One form of conducting such contact would be for the customer service representatives to place test orders, comprising some number of items selected from the merchant's catalogue. The customer service representative could then communicate with the merchant to confirm the contents of the order. However, this consumes time from customer service representatives, who, depending on the number of merchants participating in the shopping service, may spend significant time contacting member merchants.

### OBJECTS OF THE DISCLOSED SHOPPING SERVICE

An object of the disclosed shopping service is to provide a third party shopping service that maintains a high level of reliable order fulfillment;

Another object of the disclosed shopping service is to provide a third party restaurant delivery service that maintains a high level of reliable order fulfillment;

Another object of the disclosed shopping service is to provide a third party restaurant delivery service that tests the responsiveness of participating restaurants with test orders;

Another object of the disclosed shopping service is to provide a third party restaurant delivery service that provides for automatic generation of test orders;

Another object of the disclosed shopping service is to provide a third party restaurant delivery service that automatically generates test orders that minimize inconvenience to fulfilling restaurants if the test orders are accidentally prepared;

Other advantages of the disclosed shopping service will be clear to a person of ordinary skill in the art. It should be understood, however, that a system, method, or apparatus could practice the disclosed shopping service while not achieving all of the enumerated advantages, and that the protected shopping service is defined by the claims.

### SUMMARY OF THE INVENTION

A restaurant service automatically generates test orders to ensure that participating restaurants are reliably servicing customers. A monitoring computer, which may be attended by a customer service representative, generates a test order for a particular restaurant as needed. A database stores structured data relating to menus and restaurants, as well as an order queue. The monitoring computer selects items from the menu of a particular restaurant so that selected items minimize the inconvenience and cost to restaurants that accidentally prepare a test order. The monitoring computer places the generated test order into an order queue, which is processed by a back office computer that communicates the order to the restaurant. The restaurant then confirms reception of the order.

### BRIEF DESCRIPTION OF THE DRAWINGS

Although the characteristic features of this invention will be particularly pointed out in the claims, the invention itself, and the manner in which it may be made and used, may be better understood by referring to the following description taken in connection with the accompanying drawings forming a part hereof, wherein like reference numerals refer to like parts throughout the several views and in which:

FIG. 1 is a simplified system diagram of the disclosed third party restaurant service;

FIG. 2 is a flowchart depicting the process by which test orders are generated and confirmed by the disclosed third party restaurant service;

FIG. 3 is a generalized depiction of a test order generated by the disclosed third party restaurant service;

FIG. 4 is a simplified schematic view of a potential physical architecture of the disclosed third party restaurant service;

FIG. 5 is a block diagram of a potential software architecture of the disclosed restaurant service.

### DETAILED DESCRIPTION OF THE ILLUSTRATED EMBODIMENT

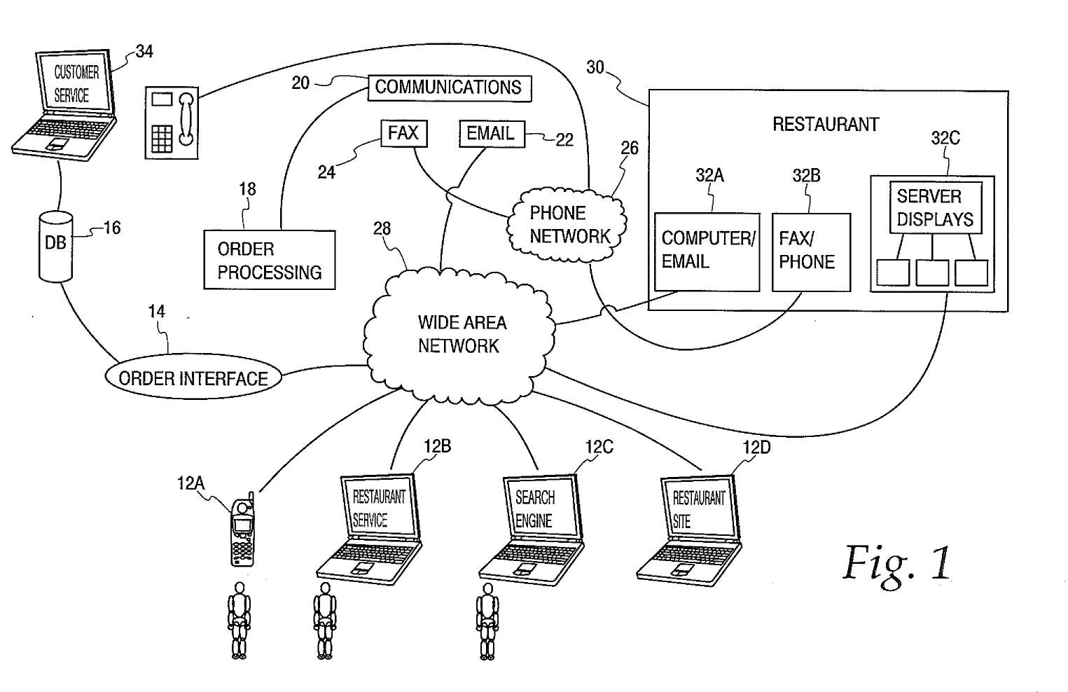

Turning to the Figures and to FIG. 1 in particular, a simplified illustration of a third party restaurant service is depicted. Diners 12a, 12b, 12c, and 12d can access the restaurant service using a number of different interfaces. Diner 12a accesses the restaurant service using a mobile phone interface, such as, for example, a smart phone application. Diner 12b accesses the restaurant service using a web interface provided by the restaurant service. Diner 12c accesses the restaurant service using a separate third party interface, such as that provided by a portal site or a search engine. Diner 12d accesses the restaurant service using a website representing the restaurant but hosted by the restaurant service. All of these diners access the restaurant service through the Internet 28 or a future replacement Wide Area communications network. All orders flow into one or more order interfaces 14. The order interface 14 provides a tailored user interface experience to each diner. For example, diner 12a accessing the restaurant service on a mobile phone will have a different user interface experience than diner 12b which is accessing the restaurant service through a consumer web site. It should be noted that the interface used by a diner to access the restaurant service will change as new technologies are developed, and is not a limitation of the disclosed restaurant service.

Based on the consumer's desired purchase, an order is created and queued in database 16. In one embodiment of the disclosed restaurant service, database 16 is a relational database. However, neither the type of database nor its means of access (via shared file, through a server, etc.) are limitations of the disclosed restaurant service. The database can maintain a number of other data points. In particular, a list of restaurants and their menus, as well information about diners. Each menu will generally comprise a list of items and associated information, such as an item description, the price of the item, and the popularity of the item, based on sales of the item through the restaurant service. Certain items, can be excluded from the popularity measure, as their popularity may be structural, and not indicative of diners' attitude toward the items; i.e., certain popular bottled drinks, such as cola drinks, bottled water, etc., are add on items for many orders, irrespective of the restaurant they are ordered from. Other such items include, but are not limited to, condiments and prepackaged foods. Items that are structurally excluded from the popularity database can be prepared in a number of different ways. For example, an account representative responsible for preparing the electronic version of a menu for a particular restaurant can consult with the restaurant to determine which items to exclude from the popularity measure. Alternatively, a master list of “add on items” can be consulted and programmatically compared to the restaurant's menu to determine which items to exclude from the list. An account representative could optionally be able to override the default. The database may also track the preparation time of each item.

The queued order is serviced by an order processing process 18. This process parses the order queue, invoices customers by, for example, charging a credit or debit card (not shown), and passes the order to communications process 20. The communications process 20 communicates the order to the restaurant 30 from which food has been ordered by the diner 12a-d. Orders can be communicated to restaurants in a variety of ways. For example, for restaurants that provide kitchen staff with access to email, an email order can be sent by an email process 22. Restaurants without access to email may have access to a fax machine. Accordingly, an order can be sent by facsimile by a telephony process 24. High tech restaurants may have direct integration with the restaurant service in their kitchen, so that orders show up directly on terminals accessible by kitchen staff.

The restaurant 30 receives email orders at a computer terminal 32a, which is coupled to a network, such as, for example, the Internet 28. Restaurants that are directly coupled to the restaurant service may include a server with a number of displays 32c that are accessible to the restaurant's kitchen staff. Orders sent via facsimile may be routed via the public phone network 26 to a fax machine 32b accessible to the restaurant's kitchen staff.

Overseeing the order process is a group of customer service representatives, each of which will have access to a computer 34 and telephone 36. Using an internal administrative interface (not shown in this figure), the customer service representatives will deal with customer issues regarding orders not being attended to, or receiving improper orders. In addition, to ensure that restaurants are responding to orders in timely fashion, customer service representatives will periodically generate test orders that are sent to restaurants. As explained further herein, these test orders include a confirmation code that the restaurant can use to confirm successful reception of the test order. A variety of methods can be used to confirm the test order, including entering the code on a telephone's keypad after receiving an automated phone call from the restaurant service, entering the code on an online portal site, or reading the number back to a customer service representative. Generally, a customer service representative of the restaurant service will not directly telephone a restaurant unless the confirmation code has not been entered after a period of time has passed and the test order has been escalated.

In the past, customer service representatives were required to manually generate test orders. This process had to be repeated for each restaurant that the customer service representative was responsible for, and could be extremely time consuming. In addition, despite clearly marking a test order as a test order, there are still occurrences of restaurants accidentally mistaking the test order as a real order and preparing it, resulting in wasted time and ingredients. The disclosed restaurant service automatically generates test orders based on a restaurant's particular menu, saving customer service representatives substantial time. In addition, the items on the test order are selected to minimize the cost to the restaurant if the order should be mistakenly prepared.

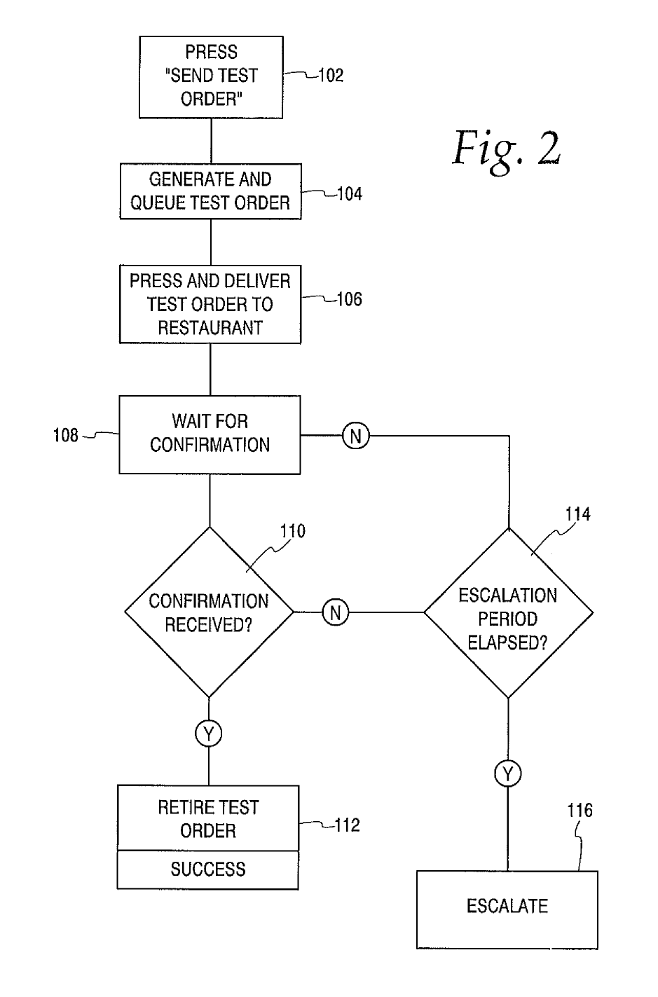

FIG. 2 illustrates the process by which customer service representatives can confirm that restaurants are responding to orders. The process is started when a customer service representative interacts with an internal administrative interface using a computer system or terminal. The internal administrative interface, which may be an order monitoring tool, has a user interface widget that allows for the automatic creation of a test order. The user interface widget may be, for example, a button labeled “Send Test Order.” In step 102, the customer service representative activates the user interface widget, which activates a routine that generates and queues a test order. The contents of the test order are discussed later herein, but are not randomly selected, but rather, are items that will cause the least loss to the restaurant if the order should be improperly displayed. The test order is actually generated and queued into the order queue in step 104. In step 106, the order is processed and delivered to the appropriate restaurant using a delivery mechanism, such as facsimile, email, or direct integration with the restaurant's order system. In step 108, the customer service representative waits for the restaurant to confirm that it has received the order. This confirmation may come through a variety of ways, such as, for example, a telephone call, an email message, or a digital message sent through the restaurants own server directly to the restaurant service's computers. If a confirmation is received at decision point 110, the customer service representative can retire the test order in step 112. Alternatively, if a confirmation is not received, a check is made to determine if an escalation period has elapsed at decision point 114. If not, execution returns to step 108, where the customer service representative waits for confirmation. However, if the escalation period has been exceeded, the customer service representative will escalate the failure to receive confirmation with the restaurant, by, for example, calling the restaurant directly and inquiring about the test order.

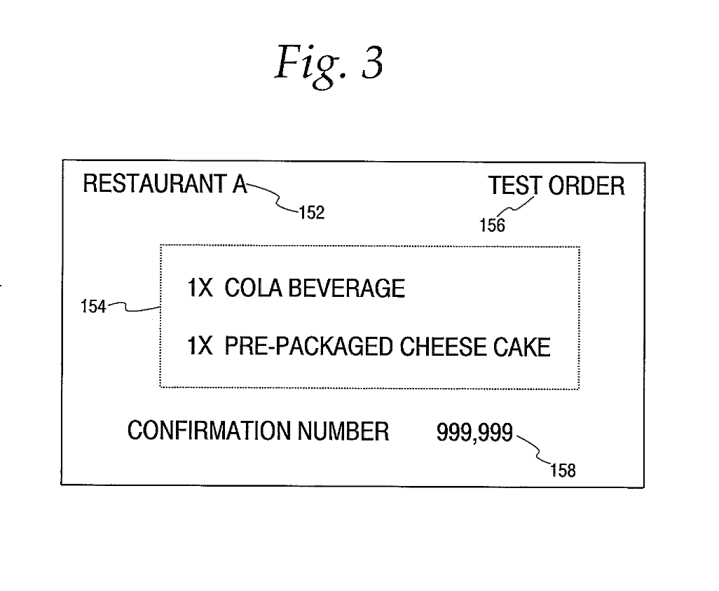

FIG. 3 depicts one possible test order 150 consistent with the disclosed restaurant service. The test order comprises a restaurant name 152, a list of items 154, an indication 156 that the test order is not to be prepared by the restaurant and a confirmation indicia 158. The confirmation indicia 158 is a simple indicia that is used to signify that the restaurant has received the test order, and may be a number, string, alphanumeric combination, or any other indicia.

The list of items 154 are selected to impose the minimum inconvenience and cost on the restaurant if the test order should be accidentally prepared. In particular, a number of rules are used to select the items that comprise the test order. One rule that can be used would be to programmatically select those items that are discarded from the popularity measurement for structural reasons. These items tend to be items that are added onto many orders, such as drinks; i.e., bottled soda or water, and “add on” items, such as bread or rice. Such items will generally not have a high cost of preparation, and are easily reused with a different order if they are accidentally prepared

The reusability of an item can also be tracked directly in the database, and a rule can be implemented that favors items that are designated as reusable. One way to track reusability would be to gather information from restaurants participating in the restaurant service regarding the reusability of each item on a restaurant's particular menu. Another way to track reusability would be to create a list of common food items that would set the default reusability setting for the items on each restaurant's menu, and allow the restaurant to override the default setting. For example, cheesecake may be designated to default to “reusable,” but a particular restaurant may use a recipe that does not lend itself to reusing a piece of cheesecake that has been prepared for delivery. That restaurant could override the default setting in the database.

An additional rule would be to favor those items with a low preparation time, if preparation time is tracked for a particular restaurant. By selecting only those items that have a low preparation time, such as bottled drinks, or prepackaged goods, a restaurant will generally not be significantly inconvenienced if a test order is accidentally prepared. As preparation time is likely to vary significantly from restaurant to restaurant, depending on individual recipes and the capabilities of particular staff members, the restaurants would likely be the best source of information regarding preparation time for individual items.

Another rule that is useful in minimizing the inconvenience and cost of the accidental preparation of test orders is to favor those items that cost less than other items. By following such a rule, if an order is accidentally prepared, the cost to the restaurant will be minimized. Further advantages can be realized by combining the rules sited above. For example, selecting items that have low preparation time as well as low cost will minimize both the inconvenience and cost to the restaurant.

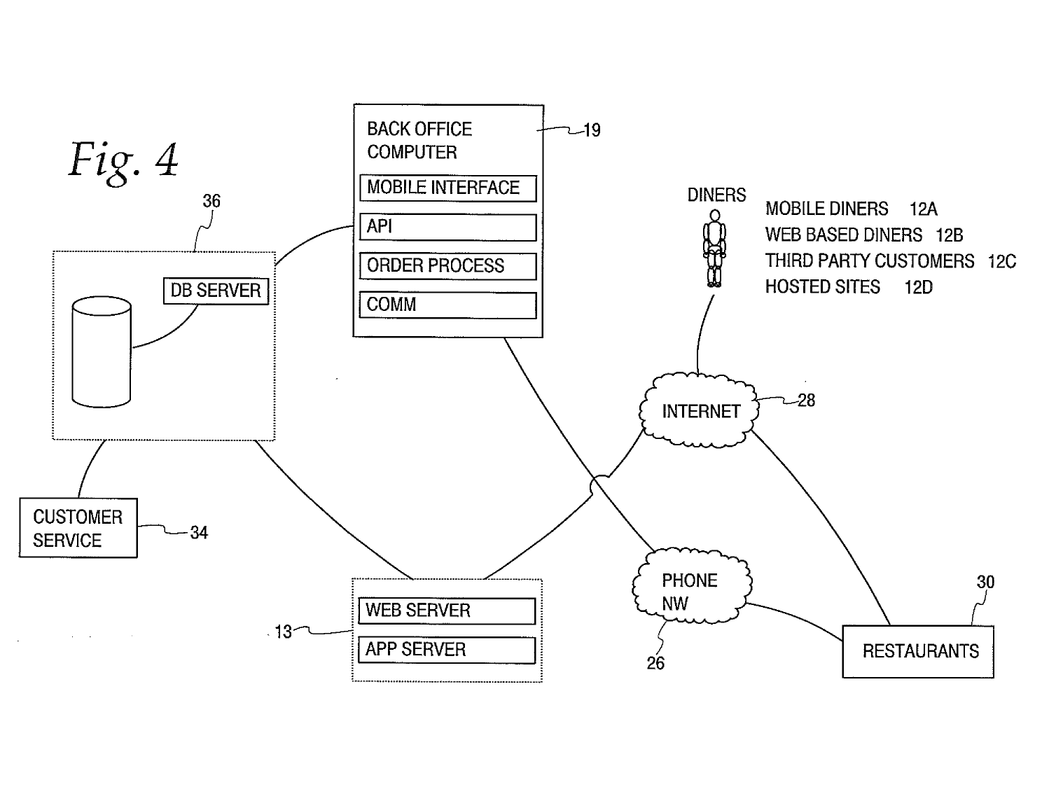

FIG. 4 illustrates one architecture for a system implementing the disclosed restaurant service. A number of diners 12a-d connect to a restaurant service through the Internet 28. A web server 13 with access to the Internet 28 or another wide area communications network hosts web server and application server applications that handle requests from web based diners 12b. A back office computer 19 hosts a number of other interface options, including a mobile application server, and an API (Application Programming Interface) server. The back office computer 19 accordingly handles orders from mobile diners 12a and third party diners 12c; i.e., those diners that are accessing the restaurant service through a third party site, such as, for example, a search engine or portal site. The back office computer may also handle requests generated by restaurant web site diners 12d that directly access the restaurant service's API. The back office computer 19 also hosts a number of other applications, including an order processing application and a data manipulation and monitoring application. The back office computer 19 has access to the Internet 28 or another wide area communications network to accept orders from various types of diners 12a,c,d, and send orders to restaurants 30 by email or direct integration, and also has access to a phone network 26 to send orders to restaurants 30 by facsimile. A customer service computer 34 has access to the database 16 to monitor orders placed by diners and to place test orders.

It should be noted that the web server 13 and the back office computer 19, may actually be multiple computers. For example, the web server application and the application server application may reside on separate computers. The applications running on the back office computer can also be segregated across multiple computers.

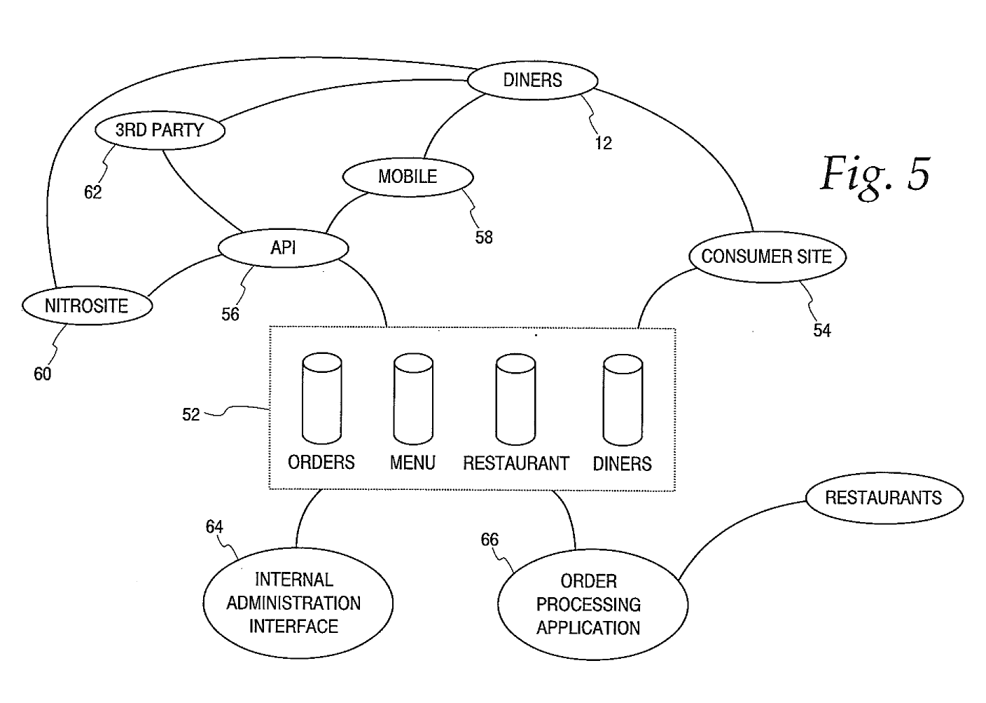

FIG. 5 illustrates one architecture for software components implementing the disclosed restaurant service. A database 52 holds a collection of ordered data, such as, for example, a set of tables, directed to key data for the restaurant service. This data includes, for example, an order queue, restaurant information, menus listing items for the restaurants, and information about registered diners that have made use of, or desire to make use of, the restaurant service. A consumer site 54 allows diners (not shown) to access the restaurant service via a web site. The consumer site 54 accepts inputs from diners and generates an order that is placed into the order queue maintained by the database 52.

A generalized application programming interface 56, which may, in one embodiment, be implemented as a restful (URL) interface. A mobile server application 58, a hosted restaurant site application 60 and any number of third party interfaces 62 utilize the application programming interface 56, which accesses the database 52 similarly to consumer site 54.

An order processing application 66 also accesses the database 52 for the purpose of servicing the order queue and communicating received orders to restaurants 30 via a telephone network, the Internet, or another wide area communications network (not shown). An internal administrative interface 64 provides customer service representatives and administrators with a means of viewing and manipulating all data stored in the databases 52.

Obviously, many modifications and variations of the present invention are possible in light of the above teachings. Thus, it is to be understood that, within the scope of the appended claims, the invention may be practiced otherwise than is specifically described above.

The foregoing description of the invention has been presented for purposes of illustration and description, and is not intended to be exhaustive or to limit the invention to the precise form disclosed. The description was selected to best explain the principles of the invention and practical application of these principles to enable others skilled in the art to best utilize the invention in various embodiments and various modifications as are suited to the particular use contemplated. It is intended that the scope of the invention not be limited by the specification, but be defined by the claims set forth below.

1. A method of issuing a test order to one or more restaurants from an online ordering system; the online ordering system including a database for maintaining an order queue comprising one or more orders, the database also maintaining a collection of menus, wherein each menu corresponds to a particular one of the one or more restaurants, a back office computer for transmitting orders to the one or more restaurants over the Internet, and the online ordering system also including a monitoring computer, the method comprising the steps of:
i) the monitoring computer accessing the database and retrieving a menu for a particular restaurant;
ii) the monitoring computer programmatically selecting from the menu one or more items to generate a test order;
iii) the monitoring computer placing the test order in the order queue;
iv) the back office computer retrieving the test order from the order queue; and
v) the back office computer communicating the order to the particular restaurant over the Internet.

2. The method of claim 1 further comprising the step of receiving an order confirmation from the particular restaurant.

3. The method of claim 2 wherein the order confirmation is received by the back office computer.

4. The method of claim 1 wherein each of the menus includes a plurality of items and wherein the database maintains an indicia indicative of the popularity of a first subset of items with restaurant customers, and wherein the database does not maintain an indicia indicative of the popularity of a second subset of items with restaurant customers, and wherein the monitoring computer incorporates a first rule into the step of selecting wherein the first rule favors items that are within the second subset of items.

5. The method of claim 4 wherein the monitoring computer incorporates a second rule into the step of selecting, wherein the second rule favors bottled drinks.

6. The method of claim 4 wherein the monitoring computer incorporates a second rule into the step of selecting wherein the second rule favors prepackaged goods.

7. The method of claim 4 wherein the database maintains an indicia indicative of the preparation time required for at least some of the plurality of items, and wherein the monitoring computer incorporates a second rule into the step of selecting wherein the second rule favors items that have a lower preparation time.

8. The method of claim 4 wherein the database maintains a price for each item, and wherein the monitoring computer incorporates a second rule into the step of selecting wherein the second rule favors items that have a lower price.

9. The method of claim 4 wherein the database maintains a field for each item designating the item as reusable or not reusable, and wherein the monitoring computer incorporates a second rule into the step of selecting wherein the second rule favors items that are designated as reusable.

10. A system for issuing test orders to one or more restaurants that participate in a restaurant service, the system comprising:
i) a database adapted to maintain an order queue and a collection of menus, wherein the order queue holds one or more orders and each menu corresponds to a particular one of the one or more restaurants;
ii) a back office computer operatively coupled to the database and operatively coupled to a wide area network, the back office computer adapted to retrieve orders from the order queue and transmit the orders to the one or more restaurants over the wide area network;
iii) a monitoring computer operatively coupled to the database, the monitoring computer including a program, the program adapted to generate a test order by programmatically selecting one or more menu items from a menu associated with a particular one of the one or more restaurants and insert the test order into the order queue; and
iv) wherein the back office computer is further adapted to transmit the test order to the particular restaurant over the wide area network.

11. The system of claim 10 wherein the back office computer is further adapted to receive a confirmation from the particular restaurant over the wide area network.

12. The system of claim 10 wherein each of the menus is adapted to include a plurality of items and wherein the database is adapted to maintain an indicia indicative of a popularity measure of a first subset of items with restaurant customers, and wherein the database does not maintain an indicia indicative of the popularity measure of a second subset of items with restaurant customers, and wherein the program incorporates a first rule adapted to favor items that are within the second subset of items.

13. The system of claim 12 wherein the program incorporates a second rule adapted to favor bottled drinks.

14. The system of claim 12 wherein the program incorporates a second rule adapted to favor prepackaged goods.

15. The system of claim 12 wherein the database is adapted to maintain an indicia indicative of a preparation time required for at least some of the plurality of items, and wherein the program incorporates a second rule adapted to favor items having a lower preparation time.

16. The system of claim 12 wherein the database is adapted to maintain a price for each item, and wherein the program incorporates a second rule adapted to favor items having a lower price.

17. The system of claim 12 wherein the database is adapted to maintain a field for each item designating the item as reusable or not reusable, and wherein the program incorporates a second rule adapted to favor items that are designated as reusable.

18. The method of claim 1 wherein functions of the back office computer and functions of the monitoring computer are performed on a same device.

19. The system of claim 10 wherein functions of the back office computer and functions of the monitoring computer are performed on a same device.
